(19) United States
(12) Patent Application Publication
(10) Pub. No.: US 2001/0047815 A1
(43) Pub. Date: Dec. 6, 2001

(54) METHOD FOR TREATING SUBSTRATES

(76) Inventors: ULRICH BIEBL, WINDEN (DE); JOHN OSHINOWO, BAD DURRHEIM (DE)

Correspondence Address: ROBERT W BECKER & ASSOCIATES, 11896 N HIGHWAY 14, SUITE B, TIJERAS, NM, 87059

(21) Appl. No.: 09/145,192

(22) Filed: Sep. 1, 1998

(30) Foreign Application Priority Data
Sep. 1, 1997 (DE) P 197 38 147.2

(51) Int. Cl. B08B 7/00; C23G 1/00; C03C 23/00; C23G 1/02; B08B 9/20; B08B 3/00

(52) U.S. Cl. 134/26; 134/2; 134/3; 134/25.1; 134/25.4; 134/28; 134/29; 134/34; 134/36; 134/41; 134/95.1; 134/95.2; 134/902

(57) ABSTRACT

A method for treating substrates in a container containing a treatment fluid includes the step of inserting the substrates into the empty container and introducing a first treatment fluid at the bottom of the container to fill the container. The first treatment fluid is displaced by introducing a second treatment fluid at the bottom of the container, wherein the first treatment fluid flows out of the container across the upper edge of the container.

### BACKGROUND OF THE INVENTION

The present invention relates to a method for treating substrates in a container containing a treatment. The substrates are guided and secured in the container by guides provided within at least one inner wall of the container. The treatment fluid is introduced at the bottom and exits by overflowing the container edge.

Methods of this kind are known from German patent 44 13 077 or German patent 195 46 999 which are owned by the instant Assignee as well as the German patent applications 196 16 402, 196 16 400, 196 37 875, 196 21 587 or 196 44 254 filed by the instant assignee but unpublished as of the filing date of this application. Even though the disclosed methods have been proven successful in practice, a method employing overflow of the treatment fluid requires a large volume of treatment fluid in order to exchange the different treatment fluids by the displacement method because multiple displacement cycles and multiple container volumes of treatment fluid are required.

From U.S. Pat. No. 4,902,350, or U.S. Pat. No. 5,313,966 methods are known in which the cassettes with substrates contained therein are introduced into a container filed with a treatment fluid. When employing cassettes, substantially larger containers and substantially larger amounts of treatment fluid are thus required. This is not only expensive but also requires large expenditures with regard to recycling, for example, with expensive cracking methods. Also, the treatment of substrates in the cassettes is more complicated and results in reduced quality as compared to a method using a container without cassettes, because the cassettes considerably impair the treatment process. A further very important disadvantage of such methods is that uniform treatment across the entire substrate surface, independent of the position of the substrates within the cassette or the container, is not possible. This is the result of, on the one hand, impairment by the cassettes in which the substrates are secured but also, on the other hand, because of the fact that the substrates enter the treatment fluid with their lower portion and, when lifted out of the container, the lower portion also remains for a longer period of time within the treatment fluid. Thus, the lower portion is subjected to a prolonged treatment as compared to the upper portion because the lower portion remains within the treatment fluid for a longer period of time. This is especially important when etching liquids are employed.

It is therefore an object of the present invention to provide a method of the aforementioned kind which eliminates the use of cassettes in the containers and provides a uniform treatment of the substrates and/or requires only a minimal volume of treatment liquid.

### SUMMARY OF THE INVENTION

Based on the aforementioned method, the object is inventively solved by the following method steps:

a) introducing the substrates into the empty cassette-free container;

b) introducing a first treatment fluid at the bottom into the container for filling the container;

c) displacing the first treatment fluid from the container by introducing a second treatment fluid at the bottom into the container.

The inventive method makes it possible to employ only a minimal amount of first treatment fluid, for example, a chemical agent such as dilute hydrofluoric acid for etching the surface of the wafers, because the required fluid volume only corresponds to the volume of the container.

The complete exchange of the first treatment fluid with a second treatment fluid is possible with a larger amount of second treatment fluid because the removal of the first treatment fluid is substantially simplified and faster because of the elimination of the cassette. A special advantage of the inventive method is that the uniform treatment of the substrates with respect to conventional methods is substantially improved because the lower portions of the substrate which, according to method step b) come into contact with the treatment fluid first and thus are exposed to the treatment fluid for a longer period of time, are thus first freed of the first treatment fluid by introducing the second treatment fluid at the bottom of the container. Accordingly, the upper portions of the substrates, upon introduction of the first treatment fluid according to method step b), will come into contact with later and, according to method step c), are subjected to the second treatment fluid later. With the inventive method there are not only advantages relative to the conventional method in regard to saving process medium and acceleration of the processing time, but also with respect to uniform treatment of the substrates.

According to an advantageous embodiment of the invention, the first treatment fluid, for example, an etching fluid, is allowed to reside in the fluid container for a set period of time in order to achieve a certain degree of treatment, for example, a certain desired surface removal before the second treatment fluid is in introduced and displaces the first treatment fluid.

According to a further advantageous embodiment of the invention, the substrates, after introduction of the second treatment fluid and displacement of the first treatment fluid are removed from the second treatment fluid, for example, by lifting. The second treatment fluid is preferably a rinsing fluid, for example, introduced in an amount which corresponds to a multiple of the container volume, for example, 6 to 18 times the container volume. This ensures a safe cleaning and rinsing of the substrates before they are lifted out and dried. Since the rinsing or cleaning fluid is considerably less expensive with respect to its chemical contents as well as recycling and disposal thereof, a frequent recirculating of the container volume, and thus a reliable, complete cleaning of the substrates at the end of the treatment process is possible in an inexpensive manner.

According to a special advantageous embodiment of the invention, during lifting of the substrates out of the second treatment fluid a further treatment fluid, that improves the drying process according to the Marigoni principle, is directed onto the surface of the second treatment fluid. In order to avoid repetition with regard to this drying principle, reference is made to European patent application 0 385 536 and German patent 44 13 077, which are incorporated herein by reference.

According to a further very advantageous embodiment of the invention, the method steps a), b), and c) are repeated at least once. Advantageously, drainage of the second treatment fluid via a drainage opening at the bottom of the container before repeating the method steps a), b), and c), can be performed quickly. Subsequently, a treatment with treatment fluid takes place and a drying of the substrates is thus not required in many cases. The drying process which advantageously is performed during lifting of the substrates from the second treatment fluid and especially by employing the Marigoni principle, is advantageously performed at the end of the repeated method steps a), b), and c). When repeating the method steps a), b), and c), the treatment of the substrates is performed preferably with different treatment fluids. This will be explained in the following with the aid of the disclosed examples whereby the first sequence of method steps a), b), and c), includes treatment with an etching liquid, for example, hydrofluoric acid, and upon repetition of the method steps a), b), and c) (second sequence), an ammonia-hydrogen peroxide-water mixture is used. Optionally, during the second sequence, the bath, respectively, the substrates are irradiated by mega sound.

According to a very further very advantageous embodiment of the invention, the substrates are pretreated in at least one further container before introduction into the container. Even though the further (auxiliary) container can be embodied as a container with integrated guides for the substrates, i.e., can be a container without cassette, according to a further advantageous designed of the invention, the auxiliary container can be designed for receiving a cassette with substrates contained therein. This is especially advantageous when the treatment of substrates in the auxiliary container is performed with very aggressive chemicals, for example, very hot phosphoric acid or very hot hydrofluoric acid, for example for removal of photo lacquer. The use of aggressive chemicals requires employing a certain container material, for example, quartz, while the fluid container for the subsequent method steps is preferably made of inexpensive materials, such as a plastic material or plastic material covered with a coating. The hot chemicals which have, for example, temperatures of up to 200° C. also cause material expansion within the container, and this makes it necessary to secure the substrates and cassettes. However, the precise dimensions required for securing the substrates within the guide elements at the sidewalls cannot be ensured.

### BRIEF DESCRIPTION OF THE DRAWINGS

The object and advantages of the present invention will appear more clearly from the following specification in conjunction with the accompanying drawings, in which:

FIG. 1 shows a schematic representation of the first embodiment of the inventive method,

FIG. 2 shows a schematic representation of a second embodiment of the inventive method,

FIG. 3 shows a schematic representation of a third embodiment of the inventive method,

FIG. 4 shows a schematic representation of a fourth embodiment of the inventive method, and

FIG. 5 shows a fifth embodiment of the inventive method.

### DESCRIPTION OF PREFERRED EMBODIMENTS

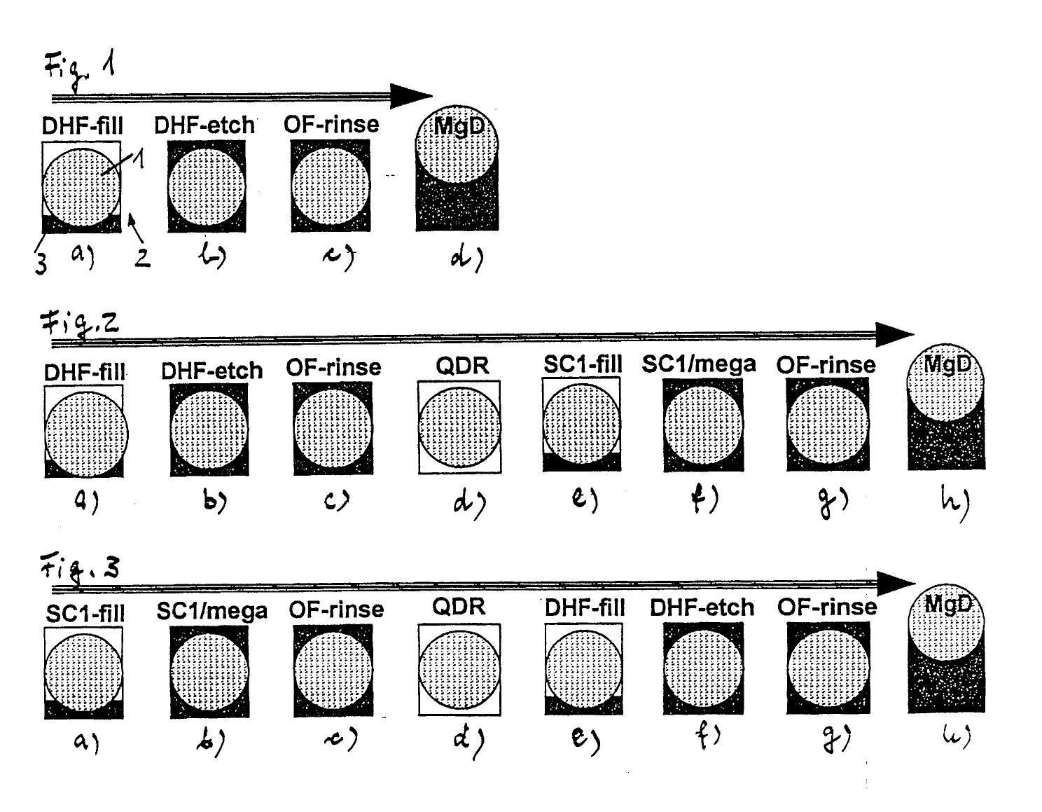

The present invention will now be described in detail with the aid several specific embodiments utilizing FIGS. 1 through 5.

In the embodiment represented in FIG. 1 the substrates 1, for example, semiconductor wafers, are introduced into an empty fluid container 2 and, subsequently, the treatment fluid 3, for example, dilute hydrofluoric acid, is introduced from the bottom into the first treatment container according to method step a). This is indicated by the lower black area labeled DHF-fill within the fluid container 2.

According to method step b), the container 2 is completely filled with the first treatment fluid 3 introduced at the bottom and the substrates 1 are treated during this method step b). This method step is labeled DHF-etch, in the drawings i.e., the substrates are etched with hydrofluoric acid.

During the subsequent treatment step c) the second fluid, for example, a rinsing fluid is introduced from below into the fluid container 2 so that the hydrofluoric acid is displaced and flows across the edges which is indicated in FIG. 1c by OF-rinse. In the subsequent method step d) it is schematically indicted that the substrate 2 is lifted out of the fluid container 2 and is dried. With the labeling MgD the Marangoni drying step is indicated.

The fluid container 2 represented schematically in FIG. 1 is a so-called single tank tool (STT) in which the fluid is introduced from the bottom and is then allowed to exit across the upper edge of the container. The substrates 1 are guided and secured in guides within the fluid container 2 which are projecting from at least one container sidewall to the interior. In order to avoid repetition with regard to such a fluid container 2 and its embodiments and function, reference is made especially to German patent applications 196 16 402, 196 21 587, 196 44 253, 196 44 254, or 196 44 255 all assigned to the instant assignee. These documents are incorporated by reference into this application.

In the shown embodiment, the first treatment fluid in the form of dilute hydrofluoric acid is employed in a concentration of 0.1% to 1%. The filling level of the fluid container 2, for example, for 200 mm wafers, is 8.5 liters. This is a minimal amount when compared to the amount of fluid required in conventional fluid containers with cassettes so that according to the present invention expensive treatment fluid is required only in minimal amounts. The rinsing liquid according to the overflow rinsing step c) is preferably deionized water and is used in an amount that corresponds to six times the volume of the container 2, i.e., is supplied in an amount of 50 liters preferably within one minute. The inventive method allows a very fast displacement, is part because of the minimal container volume, so that the treatment period is shortened and thus the productivity of the inventive method is high.

As can be seen in the illustrated method steps a) and b) of FIG. 1, a very uniform treatment of the substrates 1 results, which is especially important for the treatment and manufacturing process of semiconductor components and wafers. Upon introducing the dilute hydrofluoric acid from below into the fluid container 2 according to a method step a), the lower portion of the substrates 1 comes into contact with the hydrofluoric acid 3 first so that beginning at the lower portion gradually more material is etched off the substrate surface than in the upper area of the substrate 1. The displacement of the dilute hydrofluoric acid with the rinsing liquid from below during the method step c) ensures that the lower portions are freed at an earlier point in time from the etching hydrofluoric acid than the upper portion so that the early exposure during introduction of the hydrofluoric acid according to method step a) is compensated. Thus, across the entire width of the substrate a uniform treatment result is obtained. It is especially advantageous that with the inventive method the velocity with which the rinsing fluid 4 according to method step c) is introduced from below into the fluid container 2, can be adjusted to thereby control the uniform treatment of the substrates, i.e., to ensure that the hydrofluoric acid will act for the same amount of time onto the substrate 1. The symbols represented in FIG. 1 for the method step a) through d) will be used in the following with the same meaning.

The process sequence represented in FIG. 2 is identical to the process of FIG. 1 with respect to method steps a), b) and c). Instead of method step d) of FIG. 1 a method step d), identified as QDR (quick dump rinse), follows the method step c) in FIG. 2. It includes drainage of the rinsing fluid via a drainage opening at the bottom of the fluid container 2 after the displacement and rinsing process pursuant to the preceding method step c). Drainage is performed quickly so that the container 2 is empty as can be seen in the representation of the method step d) in FIG. 2. This makes it possible to repeat the method steps a), b) and c) according to FIG. 2 for different treatment fluids.

During method step d) a further treatment fluid, in the present case a mixture of ammonia, hydrogen peroxide, and water (identified as SC 1 fill) for intensively cleaning the substrates 1 is introduced from the bottom into the fluid container 2, and according to method step f) is kept in contact with the substrates for a set period of time. At the same time, according to this embodiment, a mega sound irradiation of the substrates is performed for further improving the cleaning process. Subsequent to this cleaning process, a second rinsing process g) is performed which corresponds to the aforementioned rinsing process d). After completion of cleaning and rinsing, the process step h) is performed which relates to the Marangoni drying as indicated by the same symbol as shown for the process d) of FIG. 1.

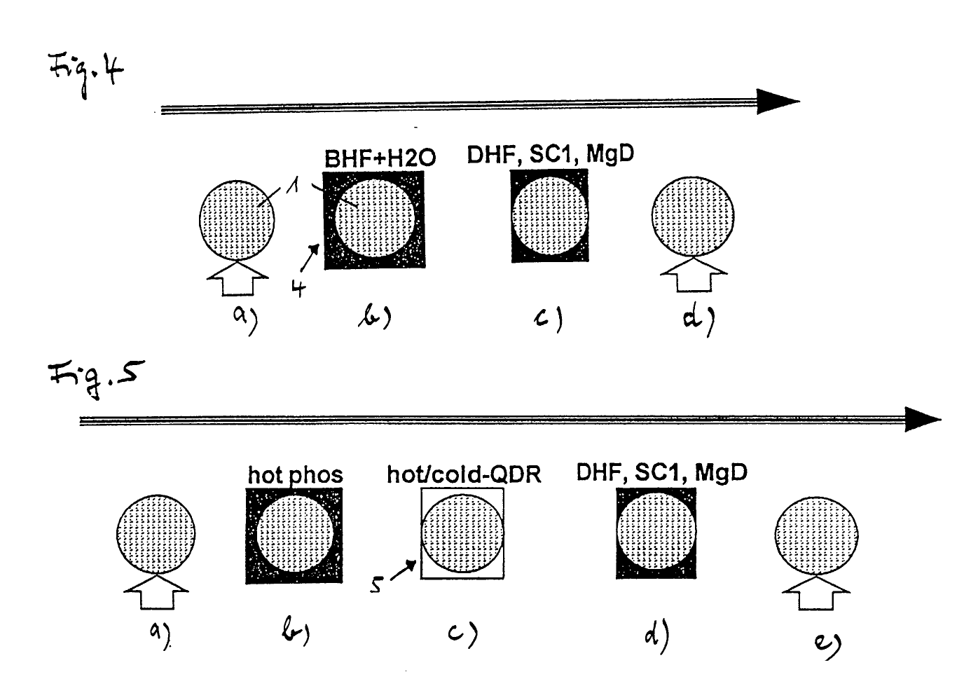

The sequence of steps according to FIG. 3 differs from the sequence in FIG. 2 only in that first the cleaning with a mixture of ammonia, hydrogen peroxide, and water and thereafter the treatment with dilute hydrofluoric acid is performed. This means, that in FIG. 2 the method steps a), b), c), represented symbolically, have been switched with method steps e), f), g).

FIG. 4 shows an embodiment of the inventive method in which an additional step is performed before the process sequence according to FIG. 1 through 3. This additional step is performed in a container 4 including a cassette for receiving wafers. In the schematically represented method step a) the wafers are inserted into the cassette with a known manipulator. The cassette filled with wafers is then introduced into the cassette container 4 as is symbolically represented in method step b). The substrates 1 do not contact the sidewalls of the container. The container 4 is filled with a treatment fluid which, with respect to the stability of the fluid container 4, requires that certain criteria are fulfilled. In the shown embodiment buffered hydrofluoric acid (in FIG. 4 shown as BHF+H₂O) is used which requires a stable material for the container. Furthermore, the liquid tends to crystalize so that special inlet openings for introduction of the treatment fluid are required. Moreover, the advantageous fluid container without a cassette cannot be used for the following treatment because crystallization would plug the fluid inlet jets which are used for introducing the fluid into the container.

In the method step c) of the FIG. 4, the method steps a), b), c), and h), according to FIG. 1, 2 or 3, are symbolically combined in order to avoid repetition. The individual method steps are symbolically identified by DHF, SC1 and MgD. Between the treatment steps b) and c), the substrates 1 are transferred from the container 4 or its cassette into the container 2 without cassette, for example, by a manipulation device, as is disclosed in German patent document 196 52 526 owned by the instant assignee.

The method step d) of FIG. 4 symbolizes the removal of the finish-treated substrates from the treatment process.

FIG. 5 shows a further embodiment of the invention which differs from the embodiment according to FIG. 4 in that a third fluid container 5 is provided between the container 4 receiving a cassette and the container 2 without cassette, i.e., between the method steps b) and c) of FIG. 4. The third container 5 is symbolically represented in the shown embodiment as a cassette-free container in which the substrates 1 are guided in guides provided at the container wall.

During method step b) the substrate are treated with hot phosphoric acid (labeled as hot phos). The labeling hot/cold-QDR in method step c) means rinsing with hot and/or cold rinsing liquids with fast fluid drainage, as disclosed, for example, in DE 196 16 402.

The third container 5 is provided in order to allow for a fast filling and drainage, i.e., not according to the overflow method, for treating (cleaning) and/or rinsing the substrates with hot and/or cold rising and/or cleaning fluid.

The third container 5 serves substantially only as a rinsing container whereby the container material can be selected such that it also withstands hot rinsing or treatment fluids.

The invention has been explained with the aid of preferred embodiments. However, to a person skilled in the art numerous variations and embodiments are obvious without deviating from the inventive principle. Even though the inventive method has been disclosed in connection with 8″ or 200 mm wafers it is also advantageously usable especially for 300 mm wafers because such large wafers make it especially difficult to provide a uniform treatment and because the larger fluid container required for their treatment make savings in regard to treatment fluid all the more important.

The specification incorporates by reference the disclosure of German priority document 197 38 147.2 of Sep. 1, 1997.

The present invention is, of course, in no way restricted to the specific disclosure of the specification and drawings, but also encompasses any modifications within the scope of the appended claims.

What is claimed is:

1. A method for treating substrates in a container containing a treatment fluid, wherein the substrates are guided and secured by guides provided within at least one inner wall of the container, said method comprising the steps of:
a) inserting the substrates into the empty container;
b) introducing a first treatment fluid at the bottom of the container to fill the container;
c) displacing the first treatment fluid by introducing a second treatment fluid at the bottom of the container, wherein the first treatment fluid flows out of the container at an upper edge of the container.

2. A method according to claim 1, including the step of allowing the first treatment fluid to reside in the container for a set period of time before step c) is carried out.

3. A method according to claim 1, further including the step of lifting the substrates out of the second treatment fluid.

4. A method according to claim 3, further including the step of directing a third treatment fluid onto the substrates during lifting of the substrates out of the second treatment fluid, wherein the third treatment fluid improves drying of the substrates.

5. A method according to claim 1, wherein said method steps a) through c) are repeated at least once.

6. A method according to claim 5, including the step of draining the second treatment fluid at the bottom of the container before repeating step a).

7. A method according to claim 5, wherein different treatment fluids are used when steps a) through c) are repeated.

8. A method according to claim 1, wherein in step c) the second treatment fluid is used in an amount that is a multiple of the container volume.

9. A method according to claim 1, wherein the second treatment fluid is a rinsing fluid.

10. A method according to claim 1, further including the step of treating the substrates in at least one auxiliary container before step a).

11. A method according to claim 10, wherein the at least one auxiliary container is embodied as a receptacle for a cassette having substrates secured therein.

12. A method according to claim 10, wherein the at least one auxiliary container is comprised of a material withstanding aggressive fluids.

13. A method according to claim 12, wherein the aggressive fluids are phosphoric acid or hydrofluoric acid.

14. A method according to claim 1, wherein the substrates are semiconductor wafers, wherein the first treatment fluid is dilute hydrofluoric acid or a mixture of ammonia, hydrogen peroxide and water.
